(19) United States
(12) Patent Application Publication
(10) Pub. No.: US 2009/0316942 A1
(43) Pub. Date: Dec. 24, 2009

(54) Headset and Method for Collecting same

(76) Inventors: Chung-Yi Huang, Taichung (TW); Yen-Ting Chu, Taichung (TW); Hsin-Hsien Wu, Taichung (TW)

Correspondence Address: HDLS Patent & Trademark Services, P.O. BOX 220746, CHANTILLY, VA, 20153-0746, US

(21) Appl. No.: 12/142,761

(22) Filed: Jun. 19, 2008

(51) Int. Cl. H04R 1/10

(52) U.S. Cl. 381/334

(57) ABSTRACT

A headset includes two sound output units and a connector connecting the two sound output units. Each of the two sound output units includes a limiting part arranged thereon. The connector is made of an elastic material and capable of being flexibly mounted to each of the limiting parts so as to improve the convenience of using the headset by making it easy to wear, adjust and collect.

### BACKGROUND

1. Field of the Invention

The present invention relates to a hearing device and a method for collecting the same and, more particularly, to a headset that is convenient to wear, adjust and collect.

2. Description of Related Art

Nowadays, various kinds of hearing devices have been widely used. One kind of hearing devices is for outputting music/voice from a music/voice player to the ears of a user. This kind of hearing devices generally includes an ear plug type, an in ear type a headset type, and so on. Another kind of hearing devices is functioned as a stethoscope. Each kind of the above hearing devices has two sound output units and a connector connecting the two sound output units.

Referring to FIGS. 1 and 2, Taiwan patent 471234 discloses a headset 1. FIG. 1 is a perspective view of the headset 1. FIG. 2 is a perspective view of the headset 1 when the headset 1 is worn by the user. The headset 1 includes two sound output units 10 and a connector 11. The two sound output units 10 are two speakers, and the connector 11 is a headband. The two speakers are connected by the headband. When the user wears the headset 1, the two speakers are respectively attached to two ears of the user, and the headband is in touch with the back of the user's head.

Because the headband of the headset 1 is positioned over the back of the user's head and does not affect the hair style of the user, the headset 1 is popular among people who care about fashions. The headband of the headset 1 is mainly made of synthetic resin alone or mixed with metal, so that the headband is rigid. Hence, an adjusting device is disposed on the headband so that the length of the headband can be adjusted based on the size of the head of the user. However, the structure of the adjusting device is complicated and, accordingly, the cost to design and manufacture the adjusting device is relatively high. Particularly, in order to match the shape of the head well, a fine adjusting device with a more complicated structure is needed. Furthermore, because the headband is made of rigid materials, a folding or expanding structure is needed to collect the headband, which further complicates the structure of the headset.

### BRIEF SUMMARY

It is an object of the present invention to provide a headset, which is convenient to wear, adjust and easy to collect.

A headset according to the present invention includes two sound output units and a connector connecting the two sound output units. Each of the two sound output units includes a limiting part arranged thereon. The connector is made of an elastic material and capable of being flexibly mounted to each of the limiting parts.

A method for collecting the above-mentioned headset includes the following steps: twisting the connector to form at least one circular part; bending the circular part towards the two sound output units; and mounting the circular part onto the two sound output units.

In the above headset, the connector is made of a material that is flexible and capable of elastically restoring to a predetermined status. When the headset is worn around the head of the user, the connector can be tightly attached to the back of the user's head. Furthermore, in order to collect the connector, the connector is first twisted, bent, and then directly mounted to the limiting parts. In this position, the connector is collected. In use, when the connector is pulled out and disengaged from the limiting part, the connector restores to the predetermined status so that the user can wear the headset. This way, it is convenient for the user to collect and expand the headset. According to the present invention, the adjusting, folding, or expanding structures of the conventional headset are eliminated, which not only reduces the cost to design and manufacture the headset but also improves the convenience of using the headset by making it easy to wear, adjust and collect.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a typical headset according to the prior art;

FIG. 2 is a perspective view of the headset depicted in FIG. 1, when the headset is worn by the user;

FIG. 3 is a perspective view of an headset according to a preferred embodiment of the present invention;

FIG. 4 is a perspective view of the headset depicted in FIG. 3, when the headset is worn by the user;

FIG. 5 is a perspective view of the headset depicted in FIG. 3, when a connector of the headset is collected in a first status;

FIG. 6 is a perspective view of the headset depicted in FIG. 3, when the connector of the headset is collected in a second status;

FIG. 7 is a perspective view of the headset depicted in FIG. 3, when the connector of the headset is collected in a third status;

FIG. 8A is a perspective view of the headset depicted in FIG. 3 when the collecting of the connector is done;

FIG. 8B is another perspective view of the headset depicted in FIG. 8A viewed from another direction;

FIG. 9 is a partially perspective view of a headset according to another preferred embodiment of the present invention; and

FIG. 10 is a perspective view of a headset according to another preferred embodiment of the present invention.

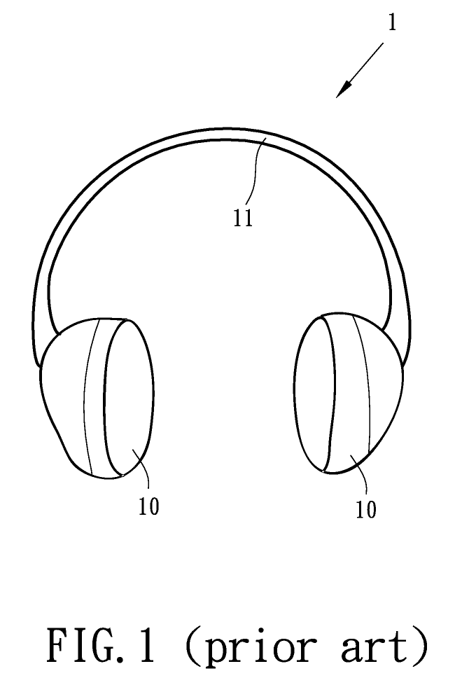

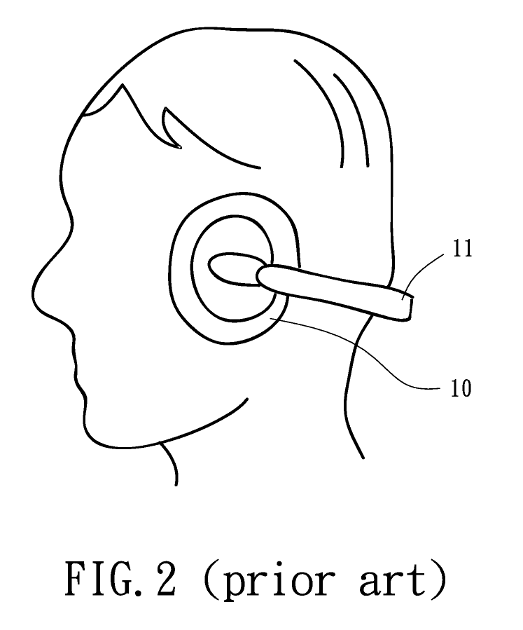

### DETAILED DESCRIPTION

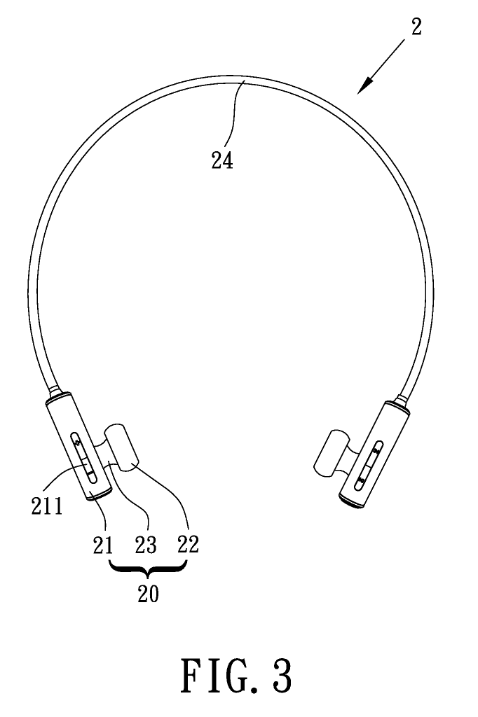

Referring to FIG. 3, a headset 2 according to a preferred embodiment of the present invention is provided. The headset 2 includes two sound output units 20 and a connector 24. Each sound output unit 20 includes a controller 21, a sound output part 22, and a limiting part 23. Two opposite ends of the connector 24 are connected with the two controllers 21 of the two sound output units 20 respectively. The limiting part 23 is formed between the controller 21 and the sound output part 22.

The limiting part 23 is a bridging part between the controller 21 and the sound output part 22. The controller 21, the sound output part 22 and the limiting part 23 can be integrally formed. Also, the controller 21, the sound output part 22 and the limiting part 23 can be combined together by three separate components through bolting, welding, or gluing engagement. It should be noted that the diameter of the limiting part 23 is less than that of the sound output part 22 so that the limiting part 23 and the sound output part 22 cooperatively form a mushroom shape.

The sound output part 22 has a speaker disposed therein. The speaker at least includes a diaphragm, a voice coil, a magnet, and a circuit board. The controller 21 includes a control circuit unit arranged therein and electrically connected to the circuit board of the speaker. The control circuit unit performs the functions, such as playing a song, adjusting the volume, and choosing a song, by pressing or touching a button group 211, which is arranged on the controller 21. In addition, the control circuit unit inside the controller can also have a wireless transmission module. The wireless transmission module is configured for receiving wireless control signals from outside, for example, the control signals transmitted under the specification of the Bluetooth system.

The connector 24 can be made of shape memory alloy covered by plastic, or elastic plastic. The connector 24 can be formed in a shape of a headband or a taenia. The elastic plastic can be, for example, synthetic rubber or a polyurethane material. The connector 24 in this embodiment is flexible and capable of elastically restoring to a predetermined status when a force within a certain range is applied thereupon. No matter what shape the connector 24 is bent into, the connector 24 is capable of elastically restoring to a predetermined shape of the design. In the present embodiment, the predetermined shape of the connector 24 is an inverted U-shape.

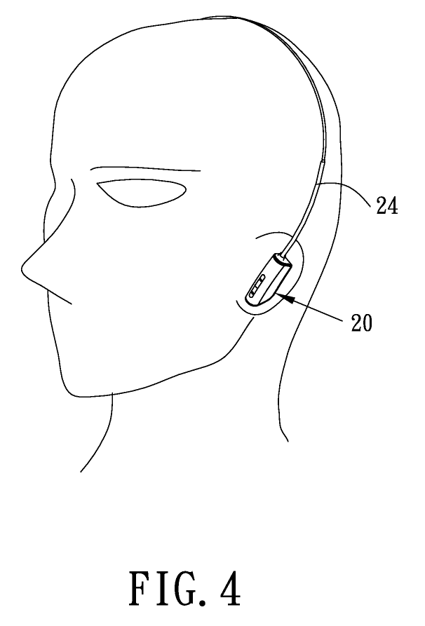

Referring to FIG. 4, when the headset 2 of FIG. 3 is worn around the head of the user, the two sound output units 20 are respectively attached to the left ear and the right ear of the user. The sound output parts 22 are inserted into the ear canal of the user, and the connector 24 is over the back of the user's head. The headset 2 of the present invention can be directly worn around the head when in the natural status. Because of the property of the elastic material used in the connector 24, the user can adjust the headset 2 to the most suitable position based on the size of the head thereof.

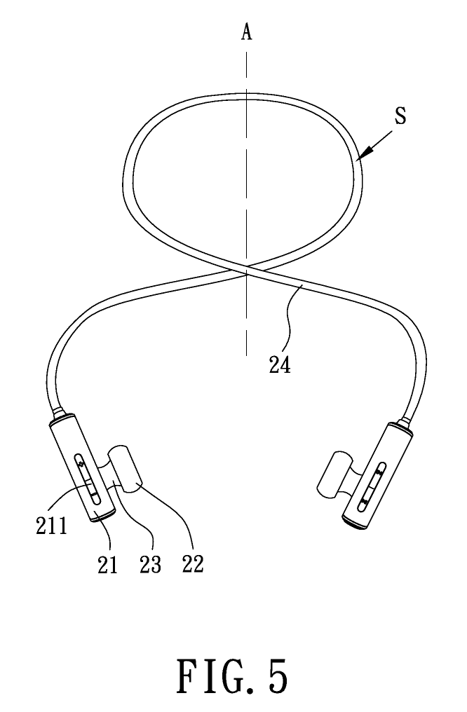

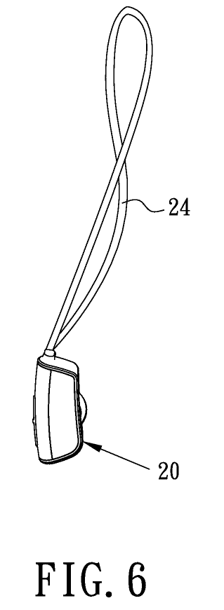

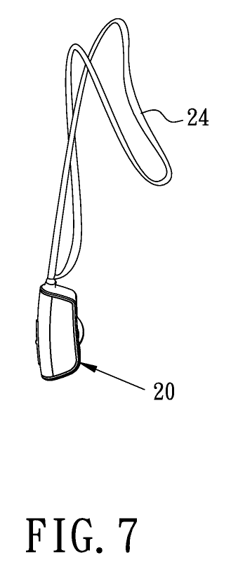

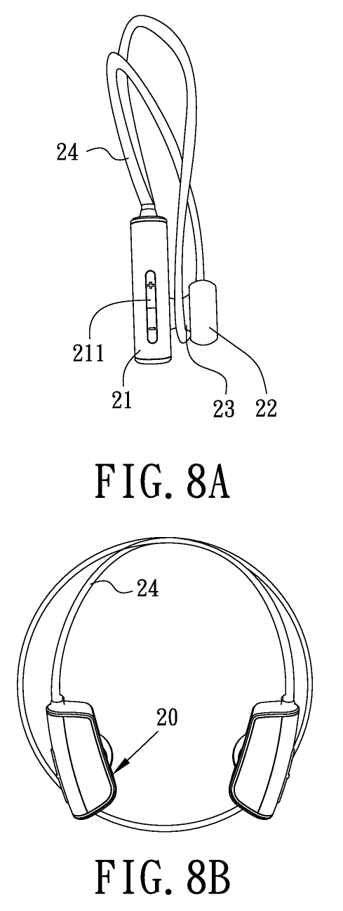

The method for twisting and collecting the connector 24 is shown in FIGS. 5 to 8A. Referring to FIG. 5, the connector 24 is first turned 180 degrees relative to its central axis A, thus forming a circular part S in the middle thereof. Referring to FIGS. 6 and 7, the circular part S is then bent towards the two sound output units 20. Finally, referring to FIGS. 8A and 8B, the circular part S is mounted to the limiting parts 23 of the two sound output units 20. When the circular part S is pulled beyond the limiting part 23 and then released, the circular part S reaches to such a position that the circular part S is tightly mounted to the limiting part 23 because the connector 24 is made of the elastic material. The limiting parts 23 restrict the vertical position of the connector 24, and at the same time, the sound output parts 22 prevent the connector 24 from sliding from the limiting parts 23 in the horizontal direction. In this way, the connector 24 is firmly mounted to the two sound output units 20. As a result, the headset 2 now only occupies half of the initial volume that the headset 2 takes in the initial status. When the user disengages the connector 24 from the limiting parts 23, the connector 24 restores to the initial status shown in FIG. 3 due to the elastic restoring property of the connector 24.

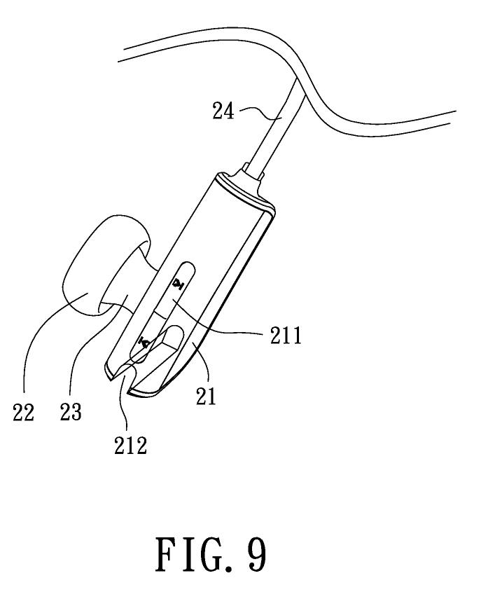

Referring to FIG. 9, a headset according to another preferred embodiment is shown. The headset according to the present embodiment is mainly different from the headset according to the above-mentioned embodiment in that the controller 21 of the sound output unit 20 has a recess 212 defined therein at the bottom thereof. The recess 212 is functioned as the limiting part. In order to collect the connector 24, the circular part S is first pulled down beyond the recess 212 and then released. After the circular part S is released, the connector 24 reaches such a position that the circular part S of the connector 24 is hooked in the recess 212 because of the elastic restoring property of the connector 24. The advantages of the present embodiment are almost the same as that of the above-mentioned embodiment. The advantages are not reiterated here.

Alternatively, the connector 24 may include a magnetoconductive element (e.g., a metal plate) disposed therein. The circular part S formed by twisting can be bent and then mounted to the two sound output units 20 through magnetic attraction force because the sound output part 22 has a magnetic device (e.g., a magnet). In this case, the magnet inside the sound output part 22 functions as the limiting part. Also alternatively, the connector 24 can have a magnet disposed thereon, and correspondingly, each of the two sound output units 20 can have a magnetoconductive element (e.g., a metal plate) disposed therein. In that case the circular part S can also be mounted to the two sound output units 20 through magnetic attraction force similarly.

It should be noted that in the headsets of all the above-mentioned embodiments, the sound output units 20 can be an in ear type, an ear plug type, or an ear attached type. In the embodiment shown in FIG. 3, the sound output units 20 are the ear canal type. In the headset of FIG. 3, when the sound output parts 22 are designed to be small size and long so that the sound output parts 22 can insert the ear canal, the sound output units 20 are the in ear type. In the headset of FIG. 9, when the sound output part 22 is directly disposed in the controller 21, the sound output units 20 are the ear attached type.

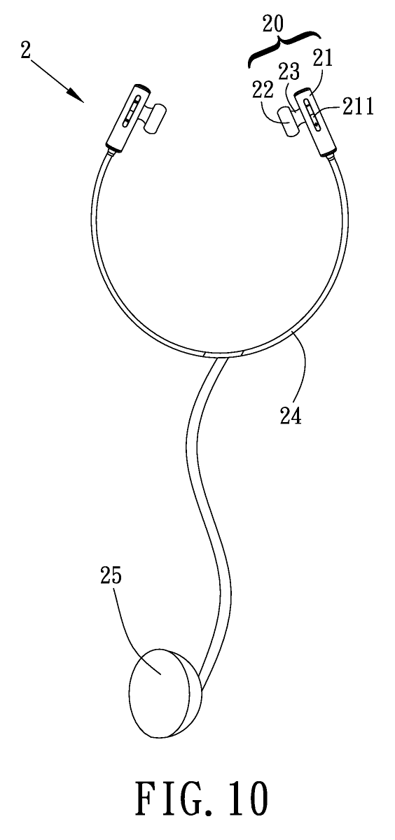

Referring to FIG. 10, a headset according to another preferred embodiment of the present invention is shown. The main difference between the present embodiment and the previous embodiment is that a pick-up 25 is connected with the connector 24. The pick-up 25 is configured for receiving the sound from outside. The sound is then transmitted to the sound output unit 20 through the connector 24. One example of the present embodiment is a stethoscope. When the pick-up 25 contacts the human body, the user can hear the sound generated by the vibration of the viscera using the sound output unit 20. In the present embodiment, the connector 24 is flexible, so that the user can collect the connector 24 quickly and conveniently.

In the above embodiments, the connector is made of a material that is flexible and capable of elastically restoring to a predetermined status. When the headset is worn around the head of the user, the position of the headset can be fixed by inserting the sound output parts in the ear canal of the user, and the connector can be tightly attached to the back of the user's head. Accordingly, it is unnecessary to manually adjust the length of the connector using complicated structure compared with the conventional headset. Furthermore, in order to collect the connector, the connector is first twisted, bent, and then pulled beyond the limiting parts. Subsequently, the connector restore to such a position that the connector is mounted to or hooked to the limiting parts. In this position, the connector is collected. Also, the connector can be directly drawn towards the sound output units and then attracted by the sound output units through the magnetic force therebetween. The connector is collected this way. In use, when the connector is pulled out and disengaged from the limiting part, the connector restores to the predetermined status so that the user can wear the headset. Compared with the traditional headset, it is very simple and convenient for the user to collect the connector and release the connector. In addition, the headset of the present invention has a simpler mechanical structure than the conventional headset by eliminating the folding or expanding structure.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A headset comprising:
two sound output units, each comprising a limiting part arranged thereon; and
a connector connecting the two sound output units;
wherein the connector is made of an elastic material and capable of being flexibly mounted to each of the limiting parts.

2. The headset of claim 1, wherein the connector is made of shape memory alloy covered with plastic.

3. The headset of claim 1, wherein the connector is made of elastic plastic.

4. The headset of claim 1, wherein each of the sound output unit comprises a controller and a sound output part, the controller being configured for controlling the sound output part to output a sound.

5. The headset of claim 4, wherein the limiting part connects the sound output part and the controller for the connector to be mounted thereon.

6. The headset of claim 5, wherein the controller, the sound output part and the limiting part are integrally formed.

7. The headset of claim 5, wherein the diameter of the limiting part is less than that of the sound output part.

8. The headset of claim 4, wherein the limiting part is a recess defined in the controller, the recess being configured for hooking the connector therein.

9. The headset of claim 4, wherein the controller comprises a button group arranged thereon.

10. The headset of claim 4, wherein the controller comprises a wireless transmission module configured for receiving wireless control signals from outside.

11. The headset of claim 1, wherein the two sound output units are mounted to the connector by magnetic attraction force.

12. The headset of claim 11, wherein each of the limiting parts is a magnetic device, and the connector further comprises a magnetoconductive element for attracting the magnetic device of the two sound output units.

13. The headset of claim 11, wherein the connector further comprises a magnetic device disposed therein, and each of the limiting parts is a magnetoconductive element for attracting the connector.

14. The headset of claim 1, wherein the connector further comprises a pick-up configured for receiving the sound from outside.

15. A method for collecting an headset, the headset comprising a connector and two sound output units, the connector being resilient and capable of being flexibly deformed, the two sound output units being connected to two opposite ends of the connector, each of the two sound output units comprising a limiting part, the method for collecting the headset comprising the following steps:
twisting the connector to form at least one circular part;
bending the circular part towards the two sound output units; and
mounting the circular part onto the two sound output units.

16. The method of claim 15, wherein each of the sound output units comprises a sound output part and a controller, the limiting part connects the sound output part and the controller, and the limiting part is configured for mounting the connector thereon.

17. The method of claim 16, wherein the circular part of the connector is mounted to the limiting part.

18. The method of claim 15, wherein the limiting part is a recess defined in each of the two sound output units, the recess being configured for hooking the connector therein.

19. The method of claim 18, wherein the circular part of the connector is hooked to the sound output units.

20. The method of claim 15, wherein the circular part of the connector is attracted to the two sound output units by magnetic attraction force.
